(19) United States
(12) Patent Application Publication
(10) Pub. No.: US 2015/0186904 A1
(43) Pub. Date: Jul. 2, 2015

(54) System And Method For Managing And Forecasting Power From Renewable Energy Sources

(71) Applicant: International Business Machines Corporation, Armonk, NY (US)

(72) Inventors: Supratik Guha, Chappaqua, NY (US); Hendrik F. Hamann, Yorktown Heights, NY (US); Levente I. Klein, Tuckahoe, NY (US); Sergio A. Bermudez Rodriguez, Croton on Hudson, NY (US)

(73) Assignee: International Business Machines Corporation, Armonk, NY (US)

(21) Appl. No.: 14/141,711

(22) Filed: Dec. 27, 2013

(51) Int. Cl. G06Q 30/02; G06Q 10/06; G06Q 50/06

(52) U.S. Cl. CPC G06Q 30/0202; G06Q 50/06; G06Q 10/06316

(57) ABSTRACT

Techniques for managing and forecasting power from renewable energy sources, such as solar and wind power, are provided. In one aspect, a computer-implemented method for managing power from at least one renewable energy source is provided. The method includes the following steps. A list of tasks to be performed within a given timeframe is created, wherein a power load is associated with performing each of the tasks. Performance of the tasks is prioritized based on the power load associated with each of the tasks and an availability of the power from the renewable energy source during the given timeframe.

### FIELD OF THE INVENTION

The present invention relates to renewable energy sources such as solar and wind power and more particularly, to techniques for forecasting and managing power from renewable energy sources.

### BACKGROUND OF THE INVENTION

With the increasing costs of energy and finite supplies of energy-related resources, the wide-scale implementation of renewable energy resources, such as wind and solar power, is the primary focus of much research in the field. Environmental concerns related to the use of traditional energy sources, such as coal, oil natural gas and nuclear power, even further bolster the need for more wide spread use of environmentally friendly wind and solar power.

One hurdle yet to be overcome in wind and solar power implementation is reliability or intermittency. In contrast to traditional energy sources (coal, oil, gas, nuclear) renewable energy sources (wind and solar) are subject to sudden disruptions and difficult to predict intermittencies, for example by sudden cloud cover or an abrupt drop in wind which can result in drop of power. In general, for the consumer or industrial market, a constant supply of power is required. Typically, energy generated when sunlight and wind are available could be stored in batteries for later use. Batteries are however not well suited at present for large-scale use and in many instances are just used to supplement power obtained from conventional sources. Because the storage of energy is still a major challenge, it is very important to develop technologies to more efficiently utilize energy from renewable energy sources when it is available.

Therefore, techniques for managing and predicting the energy available from these renewable energy sources would be desirable.

### SUMMARY OF THE INVENTION

The present invention provides techniques for forecasting and managing power from renewable energy sources, such as solar and wind power. In one aspect of the invention, a computer-implemented method for managing power from at least one renewable energy source is provided. The method includes the following steps. A list of tasks to be performed within a given timeframe is created, wherein a power load is associated with performing each of the tasks. Performance of the tasks is prioritized based on the power load associated with each of the tasks and an availability of the power from the renewable energy source during the given timeframe.

In another aspect of the invention, a system for managing power use in a building containing one or more appliances, wherein at least a portion of the power comes from a renewable energy source is provided. The system includes one or more sensors associated with each of the appliances; and a controller adapted to receive data from the sensors. The controller is configured to create a list of tasks to be performed by the appliances within a given timeframe, wherein a power load is associated with performing each of the tasks; and prioritize performance of the tasks based on the power load associated with each of the tasks and an availability of the power from the renewable energy source during the given timeframe.

A more complete understanding of the present invention, as well as further features and advantages of the present invention, will be obtained by reference to the following detailed description and drawings.

### BRIEF DESCRIPTION OF THE DRAWINGS

FIG. 1 is a diagram illustrating a network containing at least one renewable energy source according to an embodiment of the present invention;

FIG. 2 is an exemplary current-voltage (IV) curve for a solar cell according to an embodiment of the present invention;

FIG. 3 is a diagram illustrating a power management system according to an embodiment of the present invention;

FIG. 4 is a diagram illustrating an exemplary methodology for managing use of energy generated by renewable energy sources, such as solar/wind power according to an embodiment of the present invention;

FIG. 5 is a diagram illustrating an exemplary software platform hosted on a measurement and management technology (MMT) sever according to an embodiment of the present invention; and

FIG. 6 is a diagram illustrating an exemplary apparatus for performing one or more of the methodologies presented herein according to an embodiment of the present invention.

### DETAILED DESCRIPTION OF PREFERRED EMBODIMENTS

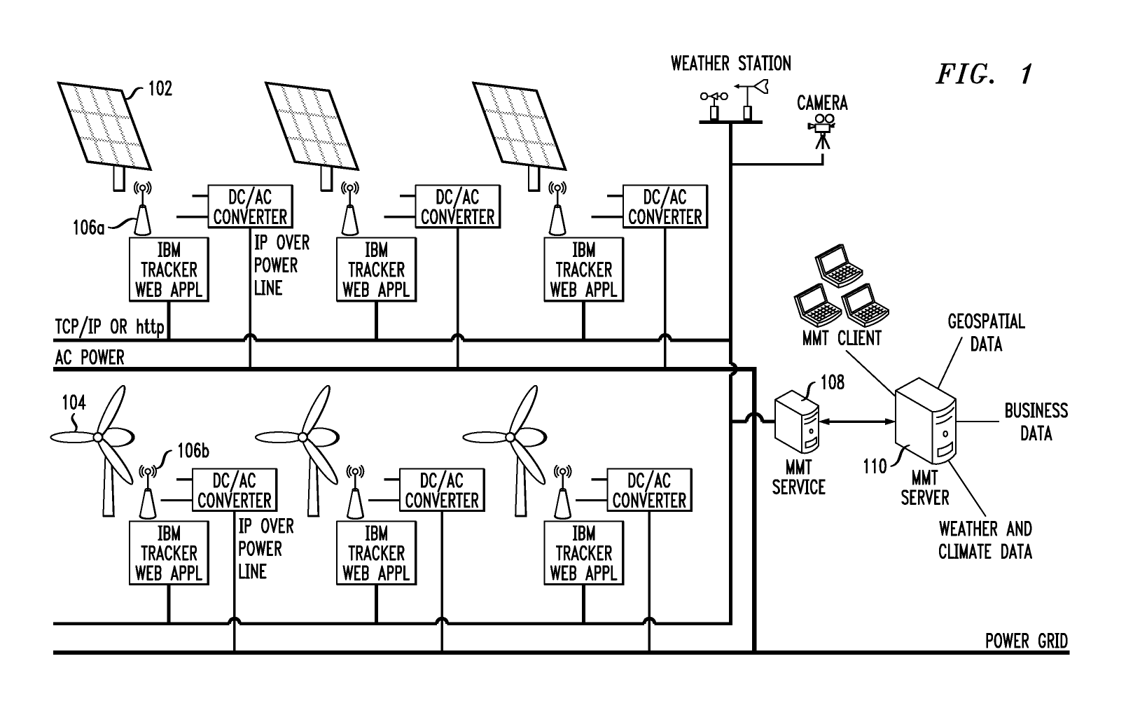

Provided herein are techniques for managing, optimizing and forecasting power delivery from a system that utilizes at least one renewable energy source, such as wind and/or solar power. An overview of the present techniques is depicted in FIG. 1 which illustrates a network containing at least one renewable energy source. A solar energy source is depicted in FIG. 1 as solar panels 102 and a wind energy source is depicted as wind turbines 104. The renewable energy sources shown in FIG. 1 are however only exemplary and are being used merely to illustrate the present techniques. What is important is that at least one renewable energy source is present.

As is known in the art, a wind turbine is a device that uses kinetic energy from the wind to produce electricity. Generally, the turbines are connected to a shaft that when rotated by the wind drive an electrical generator. To operate, the turbines need to be positioned in the path of the wind. This may be accomplished through the use of a servo motor that can pivot the turbines according to the direction of the air flow. By way of example only, air flow sensors can be used to detect the direction of the air flow and the servo motor can position the turbines accordingly. The air flow sensor and servo positioning motor can be part of a tracker system, as described below. The amount of energy generated by the turbines is subject to the wind conditions. When there is little or no wind present, little or no electricity is generated. The present techniques serve to maximize this energy obtainable from this type of renewable energy source.

As is known in the art, solar panels are a collection of interconnected solar cells that convert the sun's energy into electricity. To operate efficiently, the solar panels need to be positioned such that their light absorbing surfaces are facing the sun. For instance, the sun's position overhead changes throughout the course of a day. Therefore, for optimal efficiency, the positioning of the solar panels (i.e., azimuth and elevation) must change accordingly. This may be accomplished through the use of a servo motor(s) that can pivot the solar panels according to the positioning of the sun in the sky. By way of example only, light sensors can be used to detect the direction of the strongest sunlight and the servo motor(s) can position the solar panels accordingly. The light sensor and servo positioning motor can be part of a tracker system, as described below.

According to an exemplary embodiment, the solar panels can be thin film, crystalline silicon or amorphous silicon-based photovoltaic systems or in another exemplary embodiment can be a concentrator photovoltaic system (FIG. 1). The amount of energy generated by the solar panels is subject to the light conditions. When clouds are covering the sun, for example, little or no electricity is generated. The present techniques serve to maximize the energy use from this type of renewable energy source by directly tying the supply with the demand using forecasting techniques to predict the available renewable energy sources.

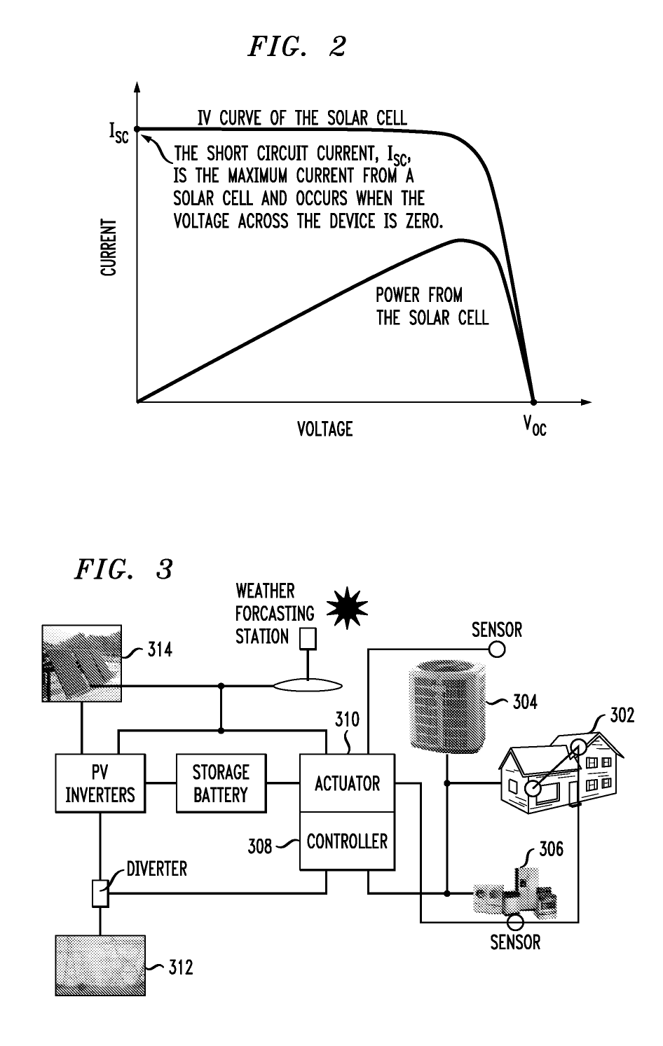

An exemplary current-voltage (IV) curve for a solar cell in one of solar panels 102 is shown in FIG. 2. However, if too much current is drawn then the voltage collapses and so does the power. To a first order, the current is proportional to the light intensity. If one of the panels is shaded and other panels are connected in serial, a cloud on one panel will bring the whole line down. In some cases bypass diodes prevent this. Also, the voltage depends on the temperature and thus panels at a lower temperature can potentially provide higher voltage at a given current and thus more power.

Each wind turbine and each solar panel produces DC power. An inverter (labeled “DC/AC converter”) adjacent to the wind turbines and solar panels converts the DC power to AC. As shown in FIG. 1, these inverters are connected to a power grid. In some cases a battery might be used on the DC side to store some of the energy generated by these energy sources. The inverter also provides DC-in and AC-out data (e.g., voltage, current, efficiencies, etc.) as well as other data depending on the inverter such as temperature, light level (intensity) via power line communication (PLC) or Ethernet communications.

PLC involves transmitting data on a conductor (i.e., wire) which also serves for electric power transmission. Most PLC technologies are limited to communications across one set of wires (for example, premises wiring), but some systems involve transmission across multiple wiring levels, for example, between both a distribution network and premises wiring. As is known in the art, PLC systems operate by imparting a modulated carrier signal on the given wiring system. Different PLC systems use different frequency bands, which can vary depending for example on the signal transmission characteristics of the wiring system at hand. For instance, many existing wiring systems are designed for transmission of AC power at a frequency of from about 50 hertz (Hz) to about 60 Hz. Thus, the PLC systems in this case would operate at similar frequencies.

Data rates and distance limitations vary widely over different PLC standards. For instance, low-frequency (i.e., from about 100 killohertz (kHz) to about 200 kHz) data transmissions on high-voltage power lines may carry one or two analog voice circuits, or telemetry and control circuits with an equivalent data rate of a few hundred bits per second. However, these transmissions may be done over long distances (i.e., over many miles). Higher data rates however generally imply shorter transmission ranges. An adapter interfaces the PLC to the network via an IP/Ethernet. This is indicated by the label “IP over power line” in FIG. 1. PLC adapters are commercially available, for example, from Panasonic or Ricoh Corp.

In addition, in the exemplary embodiment of FIG. 1 a tracker system insures that the direction of the wind turbines and/or solar panels yields optimum power delivery to the inverter. As highlighted above, the tracker system can include sensors (such as light sensors 106a and/or air flow sensors 106b) and corresponding motor actuators (e.g., servo motors) to initiate positioning changes based on sensor data. The tracker system is connected to the network via an IP/Ethernet. This is indicated by the label “IBM Tracker web appl” in FIG. 1. The tracking system yields additional data such as direction of the solar panel/wind turbine, light intensity, sun direction, air flow direction, air flow velocity, etc.

Further, as shown in FIG. 1, a weather station and a sky camera system may be connected to the network providing local weather data and cloud coverage. By way of example only, the weather station can provide information relating to temperature, humidity, wind speed, wind direction and other weather-related factors that can affect sunlight and/or wind source conditions. The information from the weather station would be real-time information. For predicting the solar radiation in the future (i.e., up to days ahead), various other measurements and methods have to be applied. One such application is a sky camera system that looks up to the sky and tracks the cloud movement. By way of example only, an image of the sky is acquired, for example, every 10 seconds and the images are processed to delineate the clouds from the background. Using numerical methods known in the art such as cross-correlation or block matching, the clouds can be projected on a trajectory to predict when they will reach the sun and for how long they will cover the sun. For a description of block matching see, for example, U.S. Patent Application Publication Number 2012/0224749 filed by Chen et al., entitled “Block Matching Method,” the entire contents of which are incorporated by reference herein (which describes using block matching for estimating a motion vector of an image frame).

Further information may also be extracted from the color and/or intensity of the clouds and the background in combination with real time measurements. For example, dark clouds will provide a higher level of shading than lighter (whiter) clouds. Thus, dark clouds will more greatly impact incident solar radiation than lighter ones, and this factor can be taken into consideration. Further, by way of example only, the measurement of the solar power in combination with the observed colors (e.g., values for red, blue and green pixels) of the camera can be used to calibrate the system. Furthermore, a sunny but humid day (high air moisture in air) would result in lower solar power than a sunny and dry day. The difference in solar power is coming from the nature of solar radiation, the radiation from the sun will be more scattered by water particles in the air (during a humid day) or aerosols. From the cloud movement observed by the sky camera system, the speed of wind and direction can be estimated based on cloud tracking.

Additional information about the solar power can be extracted through neural network modeling of the cloud movement either through images that are extracted from a large array of sky camera systems that are looking to the sky or from satellite images. The basic idea here is that time series data (such as consecutive images of the movement of clouds) can be used to train a neural network. Training is accomplished by adjusting the weights of the network, which connect the inputs to the outputs. The use of neural networks, a machine-learning technique, is known to those of skill in the art. Once trained, such a neural network allows “correlating” inputs (here measurements and images at t0) with outputs (measurements and images at t1) with t1 being later than t0, which then enables forecasting based on current observations. Different neural networks may be used depending on the “situation.” For example, one might develop a neural network for foggy conditions, and another for dry weather conditions, etc. Depending on the inputs and outputs of the neural network, additional physical models may have to be used to derive the power generated by the solar panels or wind turbines (for example, an irradiance-to-power model or a wind-to-power model). In the case of solar power, such a model would preferably include the angle of the sun, the solar radiation, the angle of the panel, the efficiency and many other effects. For instance, an online calculator is provided by the Photovoltaic Education Network for computing solar radiation on a tilted surface which accounts for the sun angle. Any other suitable irradiance models known in the art may be employed in the same manner. Suitable wind-to-power models are described, for example, in Singh et al., “Dynamic Models for Wind Turbines and Wind Power Plants, Jan. 11, 2008-May 31, 2011,” National Renewable Energy Laboratory (October 2011), the entire contents of which are incorporated by reference herein. The camera may be a sky camera that tracks cloud movement in the sky. The details of such a sky camera are discussed below.

According to an exemplary embodiment, the present techniques make use of measurement and management technology (MMT). MMT is described, for example, in U.S. Pat. No. 7,366,632, issued to Hamann et al., entitled “Method and Apparatus for Three-Dimensional Measurements” (hereinafter “U.S. Pat. No. 7,366,632”) the contents of which are incorporated by reference herein. MMT is a technology for optimizing infrastructures for improved energy and space efficiency which involves a combination of advanced metrology techniques for rapid measuring/surveying (see, for example, U.S. Pat. No. 7,366,632) and metrics-based assessments and data-based best practices implementation for optimizing an infrastructure within a given thermal envelope for optimum space and most-efficient energy utilization (see, for example, U.S. application Ser. No. 11/750,325, filed by Claassen et al., entitled “Techniques for Analyzing Data Center Energy Utilization Practices,” the contents of which are incorporated by reference herein). In this specific example, MMT is a data integrator (e.g., run on a server), providing a universal platform to read, store and model data that are coming from a variety of sources—such as the data compiled from the weather station, camera and other sensors (such as light and airflow sensors 106a and 106b) connected to the network real time power measurements from the solar panels 102 and/or wind turbines 104—e.g., via the inverters—see above—which can provide DC-in and AC-out data, image analysis from the sky camera system for solar power forecasting, statistical and neural network analysis of historical, actual and forecasted data and/or data leveraged from other external data sources and services (e.g., from the National Weather Service, see below). The data is preferably time stamped and data acquisition can be synchronized across different time and spatial extents. Namely, as shown in FIG. 1, the tracking system, the PLC-Ethernet adapter, the weather station and the camera are all connected via a private network to a server 108, which runs data and control services. The private network will allow a direct communication between various parts of the instruments to assure that data is synchronized. Once the data is processed and integrated by the MMT server the data can be sent over an Ethernet network to a central server (not shown) for further processing in order to 1) enable actuation of various components, and/or to be distributed to stakeholders or customers. The data service feeds the data collected from the weather station, camera and other sensors to an MMT server 110, while the control service receives control commands from the MMT server 110. For instance, based on the collected data (and optionally based on data collected from external sources, see below), the MMT server 110 can issue control commands related to the positioning of the solar panels/wind turbines (as described above). Specifically, the control commands can specify positioning coordinates for the solar panels/wind turbines which can be actuated by the servo motors. These control commands can be sent as a PLC transmission, Ethernet communications, or actuation through a wireless network.

As highlighted above, the MMT server 110 might leverage other external data sources and services such as commodity weather and climate data, business data and geospatial data. See FIG. 1. Commodity weather and climate data may be obtained, for example, online from the National Weather Service's National Digital Forecast Database (NDFD) Simple Object Access Protocol (SOAP) Web Service. Business data, such as real-time pricing data, may be obtained, for example, online from services such as the New York Independent System Operator (NYISO). Geospatial data may be obtained, for example, online from the Open Geospatial Consortium (OGC®).

By way of example only, weather and climate data can be used to supplement the network sensor readings and determine/predict, on a larger scale, what meteorological events may occur. For instance, the occurrence of a storm might bring about increased cloud coverage and higher speed winds. As will be described in further detail below, the present techniques relate to maximizing use of renewable energy production. Business data, such as real-time energy pricing and energy load forecasting, may be useful in determining when use of energy generated by renewable sources vis-à-vis conventional sources is optimal. For instance, when the price of energy increases, it might be beneficial to sell the energy generated by the renewable source(s) back to the grid, rather than using or storing it. Geospatial data may be relevant to estimate the amount of energy required based on population and economic activity and will dispatch the energy to locations where it is estimated (from the geospatial data) that solar energy will be most reduced due to weather variability.

In conventional systems, renewable energy sources such as solar panels/wind turbines are typically connected directly to the electric grid and are used to generate power when available. The power generated by these renewable energy sources is stored in the grid by feeding the energy produced back to the grid while using the energy required. This is most commonly accomplished by using a two-way meter that would calculate how much solar energy is fed back to the grid while at the same time calculating the KWh—power used by the consumer. Since the solar power producer will get the money based on the metering, the producer is not concerned by the intermittencies of the solar power. However, in order to maintain electric grid reliability, utility companies currently only permit up to 15% of the total power in the grid to come from renewable energy sources. The reliability issue is affected by the huge power fluctuations caused by the clouds or lack/presence of wind. One way to overcome these challenges is through the utilization of the produced power close to the production sites. In this way, the intermittencies would be consumed locally and would not be integrated into the electric grid so as not to affect a larger geographical region. One of the most obvious storage applications would be buildings where the thermal mass of the buildings and its energy use can be utilized to absorb the produced power and to eliminate the intermittencies. In one embodiment for example, based on the availability of solar power (forecasted based on the camera system), the building can be overcooled when renewable energy is available such that this cooling will maintain a comfortable environment even over the periods of time when solar power is not available and an AC unit cannot be used.

Advantageously, according to the present techniques, the power that is generated by the renewable energy sources (e.g., solar panels/wind turbines) is maximized through the use of integrated approaches where the generation and demand for energy are tied together. Namely, to optimize use of the wind/solar energy, the available power and a forecast of availability are integrated into a management system where power is dispatched to loads which are prioritized based on optimization where the needed power, time-frame, real-time energy price and comfort requirements are analyzed in real time.

Such a management system will be discussed in the context of energy consuming tasks being performed within a building(s), such as a dwelling or a place of business. See FIG. 3. By way of example only, when the building is a home 302, the tasks may include, cooling the home (by way of an air conditioning unit 304) and running appliances 306 (such as a dishwasher, a washing machine, a furnace, etc.), all of which consume power.

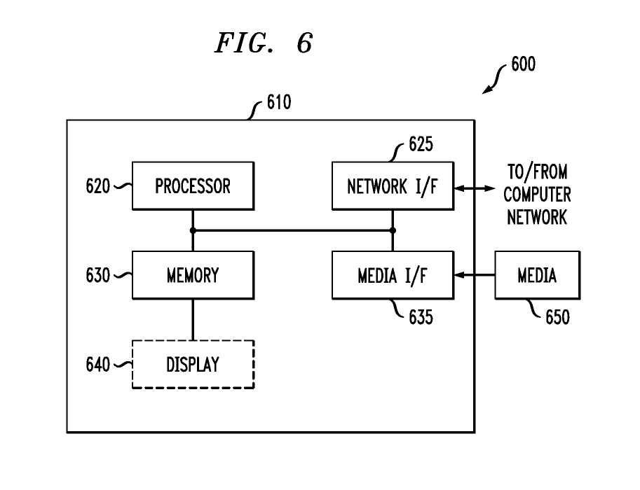

Further, according to an exemplary embodiment, performance of the tasks (including when the tasks are performed) is automated. For instance, the present techniques make use of technology that permits tasks such as setting a thermostat, turning on/off an appliance, etc. to be performed automatically under the control of a controller 308 (an apparatus that may be configured to serve as controller 308 is provided in FIG. 6, described below). This type of technology is known in the art and is sometimes referred to as home automation. In general, home automation permits a home owner (or building operator) to control remotely (e.g., via the internet) the appliances within his/her home or office. For instance, while at work a home owner might access her home's climate control system through the Internet, see what the current temperature is in her house, and lower the setting on the thermostat so that the house will be cooler when she gets home. Similarly, the homeowner can remotely turn on/off appliances via actuators that connect the appliances to a power source and are configured to be controlled remotely (e.g., via the Internet). The present techniques take advantage of this home automation technology, and will prioritize/schedule performance of the tasks when it is most beneficial to do so.

Controller 308 has built-in information technology (IT) processing which will read the aggregated information from a weather forecasting station, actual and forecasted weather data, electricity pricing from the distributors, local sensors installed in the house and on the appliances and will determine the best available option based on maintaining the comfort in the building and maximizing the financial benefits like selling the produced power back to the grid or utilizing it locally. Namely, as shown in FIG. 3, the controller 308 controls one or more actuators 310. According to an exemplary embodiment, actuators 310 are switches connecting air conditioning unit 304, appliances 306, etc. to a power source, i.e., from the power grid 312 and/or from renewable sources 314. As described above, an inverter is needed to convert the DC power (generated by the solar panels/wind turbine) into AC. The inverter can be also controlled to respond to demand by changing the maximum power set point for the produced power and adjusting the voltage and current from the solar panel/wind turbine to match the demand. Further, as shown in FIG. 3, the power generated by the renewable energy sources can be used to run the appliances, can be stored in a battery (for later use) or can be sent to the power grid (e.g., the power can be sold back to the utility, see below). This is also under the control of the controller 308. As shown in FIG. 3, a diverter is present in the link between the solar panels (and/or wind turbines) and the grid. This diverter allows the solar/wind power (when desired) to be fed back to the grid and not be used locally.

According to an exemplary embodiment, the weather forecasting station includes a sky camera which tracks cloud movement in the sky. The sky camera is a local sensor that has a time resolution from a few seconds to an hour and a spatial resolution extending up to 1.5 miles around the detection sites and is ideally suited to characterize local climate and weather close to the production level. These local methods allow specifying the cloud cover, cloud moving direction and location, and solar radiation on the building in real time and in the upcoming hour. The weather station will measure real time data while the sky camera system will be used to predict how much energy will be produced based on cloud tracking information. The sky camera system will be a network camera with a wide angle lens, plus a computer/processing software to delineate the clouds and track them as they move on the sky and are approaching the sun. By way of example only, cloud movement can be delineated using known optical flow techniques (see, for example, Bresky et al., “The Feasibility of an Optical Flow Algorithm for Estimating Atmospheric Motion,” Proc. 8^{th} International Winds Workshop, Beijing, China (April 2006), pp. 24-28, the contents of which are incorporated by reference herein) and/or using thresholding (see, for example, Doraiswamy et al., “An Exploration Framework to Identify and Track Movement of Cloud Systems,” IEEE Transactions on Visualization and Computer Graphics, Vol. 19, Issue 12 (October 2013), the contents of which are incorporated by reference herein). Cross-correlation and/or block matching (see above) are two exemplary techniques known in the art for cloud forecasting.

The sensors are connected (e.g., via a wired or wireless connection) to controller 308. According to an exemplary embodiment, one or more of the sensors are temperature sensors that are placed throughout the building. Based on the readings from the temperature sensors, the controller 308 can regulate cooling through operation of the air conditioning unit 304 via actuator 310. One or more of the sensors are associated with the appliances 306. These sensors detect, for example, whether operation of the appliance is necessary. For example, with appliances such as a washing machine or a dishwasher, it would not make sense to run these appliances unless there were articles inside needing cleaning. By way of example only, the sensors associated with the appliances could be, e.g., an acoustic sensor that sends out a small burst of sound and measures how fast the sound is reflected back. From the reflection time it can then be estimated how filled from the bottom are the appliances. When these sensors detect that the appliance is in use, then the controller 308 can schedule operation of the appliance (see below). Otherwise, the controller can detect that the appliance is not in use and not run the appliance.

Given the management system shown in FIG. 3, a methodology 400 is now provided for managing use of energy generated by renewable energy sources, such as solar/wind power. The steps of methodology 400 may be performed by controller 308 (see FIG. 3). As highlighted above, an apparatus that may be configured to serve as controller 308 is provided in FIG. 6, described below.

In step 402, the controller automatically makes a list (or schedule) of tasks that have to be performed in the building. As described above, data obtained from the sensors can alert the controller as to what tasks need to be performed. One or more parameters may be associated with each of the tasks, such as how much power is necessary to perform the task and a timeframe—for example, if a given task would require 2 kilowatt hours (kWh) for 2 hours, and if the solar forecasting predicts that this amount of energy would be available for only 1 hour, then another task should be scheduled that would consume less energy.

According to the present techniques, the tasks are performed when it is most beneficial to do so. For instance, it may be preferable to perform the tasks when there is renewable (solar/wind) power available. In this case, it would be beneficial to know when such power will be available. Thus, in step 404, information relating to when the renewable power will be available is obtained by the sky camera system/weather station. As described for example in conjunction with the description of FIG. 1, above, weather (solar/wind) data may be obtained using a variety of sensors, a weather station and from a number of external sources through an MMT server. As highlighted above, one such sensor is a sky camera.

For times when solar/wind energy is available, it may be more financially beneficial to put off one or more of the tasks and sell back the power to the utility. In that case, the power will be forwarded to the electric grid. Thus, in step 406, optionally real-time energy pricing data is obtained by the controller. As highlighted above, this pricing data may be provided by the MMT server. Current practices in the utility industry are that the utility will pay a fixed price for produced energy but the consumer may pay a variable price based on the demand. There may be situations, when demand is high, to sell back the energy rather than consume it with the appliances, as to do so would be economically more advantageous. On the other hand if it is more financially beneficial to consume the power locally then it will be directed to loads that are scheduled by an appliance that optimize the energy management in real time.

In step 408, based on the above-described parameters (step 402) (i.e., energy requirement, timeframe, etc.), energy availability (step 404) and optional pricing information (step 406), the controller prioritizes performance of the tasks. By way of example only, if the weather data indicates that, due to impending cloud coverage, solar power will only be available for the next hour, then those tasks that require the most power to complete will be prioritized first in then list.

The controller preferably has a user input interface that will allow a change in priority as determined by the optimization of best energy utilization giving the user/homeowner full control of system and scheduling based on preference. For instance, the controller might automatically prioritize running one appliance over another. However, despite this ranking, the homeowner might prefer a different sequence. The homeowner can override the controller and input his/her preferences.

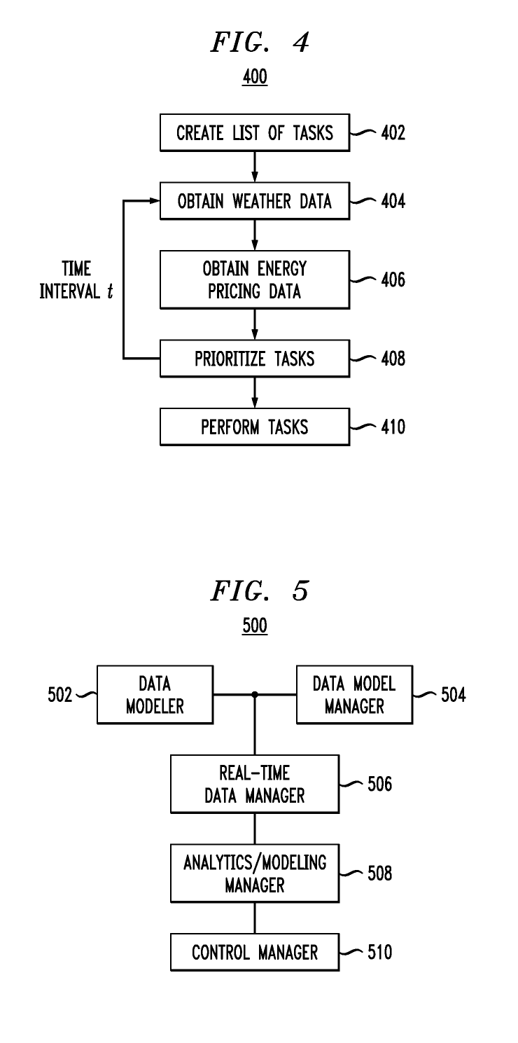

As shown in FIG. 4, at a given time interval t, steps 404-408 are repeated to obtain updated, real-time weather and pricing data. According to an exemplary embodiment, t is a duration of from about 1 minute to about 5 minutes. Based on the updated information, the list of tasks can be reprioritized, if need be. In step 410, performance of the tasks is initiated in the order of priority. As described above, the controller controls performance of the tasks through one or more actuators.

The optimization and control provided by methodology 400 allow to smoothen out the intermittencies of renewable energy sources and integrate them in building operation such that they are not transmitted to the grid. If the produced power and intermittencies are utilized locally without creating disturbances on the electric grid, the proportion of renewable energy sources can be well increased above the 15% concern level.

The sensor data and actuator and controller are processed on the MMT server, which hosts a software platform 500. See FIG. 5. A data modeler 502 describes the physical infrastructure of the solar panel (e.g., the dimensions, electrical specifications, the locations of the panels). The same is true for wind energy. The location of the wind turbine, the historical wind patterns in that region and also the way to integrate the wind energy would be part of the physical model. For example, solar power is more pronounced during the daytime while wind seems to be more prevalent during night time. The software allows managing the model interactively using visualization techniques. A spatial map can over-layed in a data model manager 504. The software also manages the data feeds, in particular real-time data in a real-time data manager 506. All data is modeled using an analytics/modeling manager 508 framework, which includes physics-based models. This model describes the power delivery as a function of weather observables (which include, cloud coverage, haziness, humidity, dew point, temperature, sun position etc.). The model also provides base line predictions. Short-term deviations will be accounted for by leveraging the camera and weather station data. A control manager 510 will synchronize between the camera, the tracking system, the weather data and the weather station so arriving clouds can be detected before shading the panels. That way the operator can make adjustments for the power delivery for example by supplementing power from other resources in order to meet power demands. The control manager can also interface with ISOs to synchronize it with the grid. The model/analytics manager also includes neural network and self-learning approaches. In addition, historical data will be leveraged to fine-tune/benchmark the physics models constantly as well as to forecast using for example time series forecasting with moving averages.

Turning now to FIG. 6, a block diagram is shown of an apparatus 600 for implementing one or more of the methodologies presented herein. By way of example only, apparatus 600 can be configured to implement one or more of the steps of methodology 400 of FIG. 4 for managing power from at least one renewable energy source. As highlighted above, the steps of methodology 400 may be performed by a controller, such as controller 308 in management system 300. Accordingly, apparatus 600 may be configured to serve as controller 308.

Apparatus 600 comprises a computer system 610 and removable media 650. Computer system 610 comprises a processor device 620, a network interface 625, a memory 630, a media interface 635 and an optional display 640. Network interface 625 allows computer system 610 to connect to a network, while media interface 635 allows computer system 610 to interact with media, such as a hard drive or removable media 650.

As is known in the art, the methods and apparatus discussed herein may be distributed as an article of manufacture that itself comprises a machine-readable medium containing one or more programs which when executed implement embodiments of the present invention. For instance, when apparatus 600 is configured to implement one or more of the steps of methodology 400 the machine-readable medium may contain a program configured to create a list of tasks to be performed within a given timeframe, wherein a power load is associated with performing each of the tasks; and prioritize performance of the tasks based on the power load associated with each of the tasks and an availability of the power from the renewable energy source during the given timeframe.

The machine-readable medium may be a recordable medium (e.g., floppy disks, hard drive, optical disks such as removable media 650, or memory cards) or may be a transmission medium (e.g., a network comprising fiber-optics, the world-wide web, cables, or a wireless channel using time-division multiple access, code-division multiple access, or other radio-frequency channel). Any medium known or developed that can store information suitable for use with a computer system may be used.

Processor device 620 can be configured to implement the methods, steps, and functions disclosed herein. The memory 630 could be distributed or local and the processor device 620 could be distributed or singular. The memory 630 could be implemented as an electrical, magnetic or optical memory, or any combination of these or other types of storage devices. Moreover, the term “memory” should be construed broadly enough to encompass any information able to be read from, or written to, an address in the addressable space accessed by processor device 620. With this definition, information on a network, accessible through network interface 625, is still within memory 630 because the processor device 620 can retrieve the information from the network. It should be noted that each distributed processor that makes up processor device 620 generally contains its own addressable memory space. It should also be noted that some or all of computer system 610 can be incorporated into an application-specific or general-use integrated circuit.

Optional video display 640 is any type of video display suitable for interacting with a human user of apparatus 600. Generally, video display 640 is a computer monitor or other similar video display.

Although illustrative embodiments of the present invention have been described herein, it is to be understood that the invention is not limited to those precise embodiments, and that various other changes and modifications may be made by one skilled in the art without departing from the scope of the invention.

What is claimed is:

1. A computer-implemented method for managing power from at least one renewable energy source, the method comprising the steps of:
creating a list of tasks to be performed within a given timeframe, wherein a power load is associated with performing each of the tasks; and
prioritizing performance of the tasks based on the power load associated with each of the tasks and an availability of the power from the renewable energy source during the given timeframe.

2. The method of claim 1, wherein the renewable energy source comprises solar power.

3. The method of claim 1, wherein the renewable energy source comprises wind power.

4. The method of claim 1, further comprising the steps of:
obtaining weather data; and
using the weather data to predict the availability of the power from the renewable energy source during the given timeframe.

5. The method of claim 4, wherein the weather data is obtained using one or more sensors.

6. The method of claim 5, wherein the sensors comprise a light sensor for detecting sunlight.

7. The method of claim 5, wherein the sensors comprise air flow sensors for detecting wind.

8. The method of claim 5, wherein the sensors comprise a sky camera for detecting cloud movement.

9. The method of claim 1, further comprising the step of:
obtaining power pricing data; and
prioritizing performance of the tasks based on the power load associated with each of the tasks, the availability of the power from the renewable energy source during the given timeframe and the power pricing data.

10. An apparatus for managing power from at least one renewable energy source, the apparatus comprising:
a memory; and
at least one processor device, coupled to the memory, operative to:
create a list of tasks to be performed within a given timeframe, wherein a power load is associated with performing each of the tasks; and
prioritize performance of the tasks based on the power load associated with each of the tasks and an availability of the power from the renewable energy source during the given timeframe.

11. The apparatus of claim 10, wherein the renewable energy source comprises one or more of solar power and wind power.

12. The apparatus of claim 10, wherein the at least one processor device is further operative to:
obtain weather data; and
use the weather data to predict the availability of the power from the renewable energy source during the given timeframe.

13. A non-transitory article of manufacture for managing power from at least one renewable energy source, comprising a machine-readable recordable medium containing one or more programs which when executed implement the steps of:
creating a list of tasks to be performed within a given timeframe, wherein a power load is associated with performing each of the tasks; and
prioritizing performance of the tasks based on the power load associated with each of the tasks and an availability of the power from the renewable energy source during the given timeframe.

14. The article of manufacture of claim 13, wherein the renewable energy source comprises one or more of solar power and wind power.

15. The article of manufacture of claim 13, wherein the one or more programs which when executed further implement the steps of:
obtaining weather data; and
using the weather data to predict the availability of the power from the renewable energy source during the given timeframe.

16. A system for managing power use in a building containing one or more appliances, wherein at least a portion of the power comes from a renewable energy source, the system comprising:
one or more sensors associated with each of the appliances; and
a controller adapted to receive data from the sensors, the controller being configured to:
create a list of tasks to be performed by the appliances within a given timeframe, wherein a power load is associated with performing each of the tasks; and
prioritize performance of the tasks based on the power load associated with each of the tasks and an availability of the power from the renewable energy source during the given timeframe.

17. The system of claim 16, further comprising a weather station, and wherein the controller is further configured to:
obtain weather data from the weather station; and
use the weather data to predict the availability of the power from the renewable energy source during the given timeframe.

18. The system of claim 17, wherein the weather station comprises a sky camera for detecting cloud movement.

19. The system of claim 16, wherein the controller is further configured to:
obtain power pricing data; and
prioritize performance of the tasks based on the power load associated with each of the tasks, the availability of the power from the renewable energy source during the given timeframe and the power pricing data.

20. The system of claim 19, wherein at least a portion of the power comes from a utility power grid, and wherein the controller is further configured to:
forward at least a portion of the power that comes from the renewable energy source to the utility power grid.
